(19) United States
(12) Patent Application Publication
(10) Pub. No.: US 2025/0167500 A1
(43) Pub. Date: May 22, 2025

(54) Connector

(71) Applicant: Tyco Electronics (Shanghai) Co., Ltd., Shanghai (CN)

(72) Inventors: Jiaoyong (Mac) Liu, Shanghai (CN); Jie (Roger) Luo, Foshan (CN); Wei Yao, Kunshan (CN); Jialin Zhang, Shanghai (CN)

(73) Assignee: Tyco Electronics (Shanghai) Co., Ltd., Shanghai (CN)

(21) Appl. No.: 18/951,996

(22) Filed: Nov. 19, 2024

(30) Foreign Application Priority Data
Nov. 21, 2023 (CN) 202311562178.0

(51) Int. Cl. H01R 25/14

(52) U.S. Cl. CPC H01R 25/142

(57) ABSTRACT

A connector comprises a housing, a terminal, a connection member, and a positioning pin. The housing has a terminal installation chamber and a pin hole. The terminal is inserted into the terminal installation chamber and has an end portion and a tail portion that are opposite to each other in a longitudinal direction of the housing. One end of the connection member is connected to the tail portion of the terminal. The positioning pin is inserted into the pin hole and passes through a through hole formed in the connection member and/or the terminal along a transverse direction of the housing to prevent the terminal from being pulled out of the housing. A diameter of the through hole is larger than that of the positioning pin to allow the tail portion of the terminal to move relative to the positioning pin in the transverse direction.

### CROSS-REFERENCE TO RELATED APPLICATION

This application claims the benefit of Chinese Patent Application No. CN202311562178.0 filed on Nov. 21, 2023 in the State Intellectual Property Office of China, the whole disclosure of which is incorporated herein by reference.

### FIELD OF THE DISCLOSURE

The present disclosure relates to a connector, particularly to a power connector.

### BACKGROUND

In the prior art, a tail portion of a power terminal in a power connector is electrically connected to a metal busbar. The tail portion of the power terminal has essentially no floating performance or ability, requiring the metal busbar connected to the tail portion of the power terminal to provide floating performance.

In addition, in the prior art, in order to improve the current carrying capacity of the power terminal, it is necessary to increase the thickness of power terminal. However, increasing the thickness of the power terminal can lead to excessive insertion force of the mating terminal, affecting the mating operation between the power terminal and the mating terminal.

### SUMMARY

According to an embodiment of the present disclosure, a connector comprises a housing, a terminal, a connection member, and a positioning pin. The housing has a terminal installation chamber and a pin hole. The terminal is inserted into the terminal installation chamber and has an end portion and a tail portion that are opposite to each other in a longitudinal direction of the housing. One end of the connection member is connected to the tail portion of the terminal. The positioning pin is inserted into the pin hole and passes through a through hole formed in the connection member and/or the terminal along a transverse direction of the housing to prevent the terminal from being pulled out of the housing. A diameter of the through hole is larger than that of the positioning pin to allow the tail portion of the terminal to move relative to the positioning pin in the transverse direction.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a connector according to an exemplary embodiment of the present invention;

FIG. 2 shows a cross-sectional view of a connector according to an exemplary embodiment of the present invention;

FIG. 3 shows an illustrative perspective view of a connector according to an exemplary embodiment of the present invention, with the housing removed;

FIG. 4 shows an illustrative perspective view of a terminal of a connector according to an exemplary embodiment of the present invention;

FIG. 5 shows an illustrative perspective view of a connection member of a connector according to an exemplary embodiment of the present invention;

FIG. 6 shows an illustrative perspective view of a layer of metal strip of a connection member of a connector according to an exemplary embodiment of the present invention;

FIG. 7 shows an illustrative perspective view of a layer of metal strip of a connection member of a connector according to another exemplary embodiment of the present invention;

FIG. 8 shows a cross-sectional view of a connector according to another exemplary embodiment of the present invention; and

FIG. 9 shows an illustrative perspective view of a terminal of a connector according to another exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided a connector. The connector comprises: a housing which is formed with a terminal installation chamber and a pin hole; a terminal which is inserted into the terminal installation chamber and has an end portion and a tail portion that are opposite to each other in a longitudinal direction of the housing; a connection member, one end of which is connected to the tail portion of the terminal; and a positioning pin which is inserted into the pin hole and passes through a through hole formed in the connection member and/or the terminal along a transverse direction of the housing to prevent the terminal from being pulled out of the housing. A diameter of the through hole is larger than that of the positioning pin to allow the tail portion of the terminal to swing left and right relative to the positioning pin in the transverse direction.

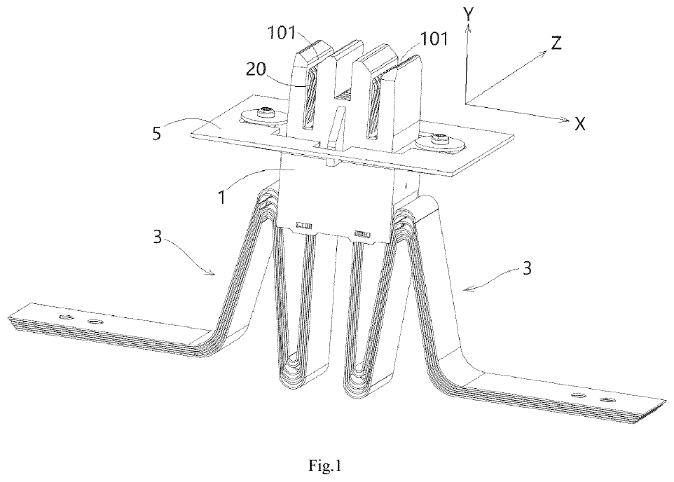

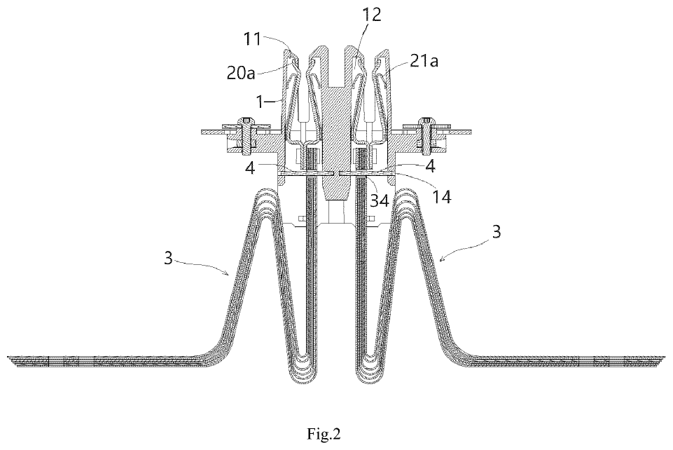

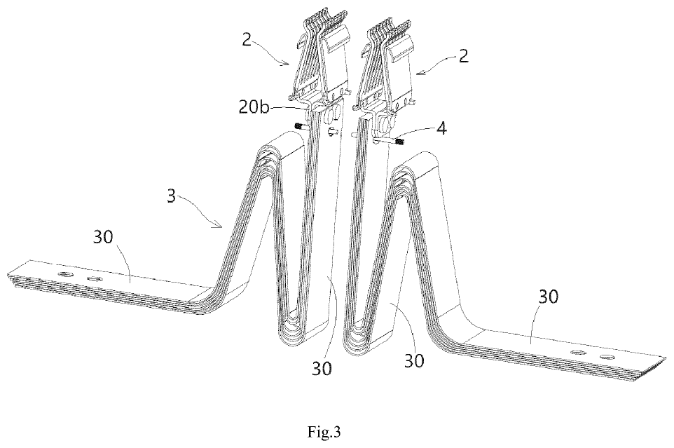

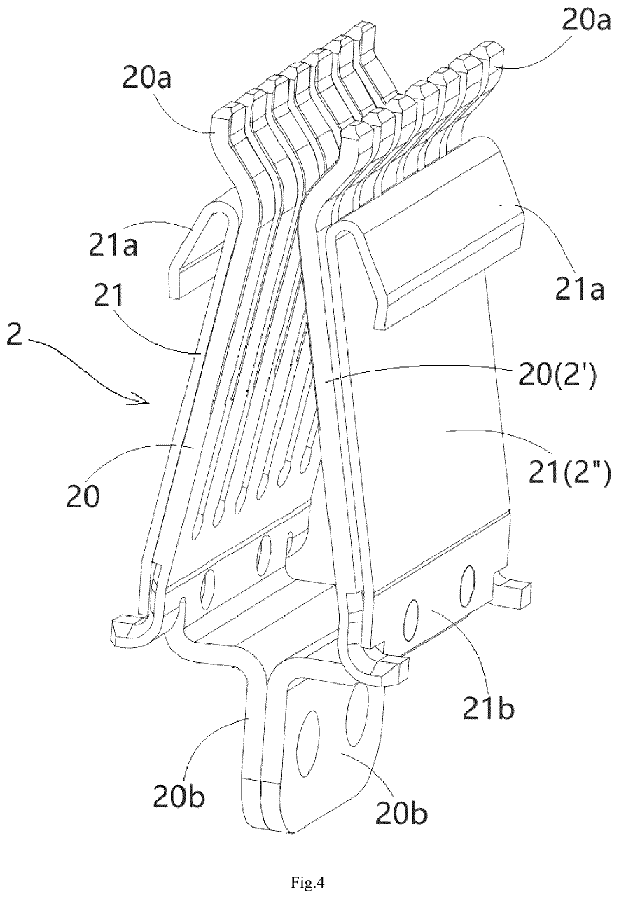

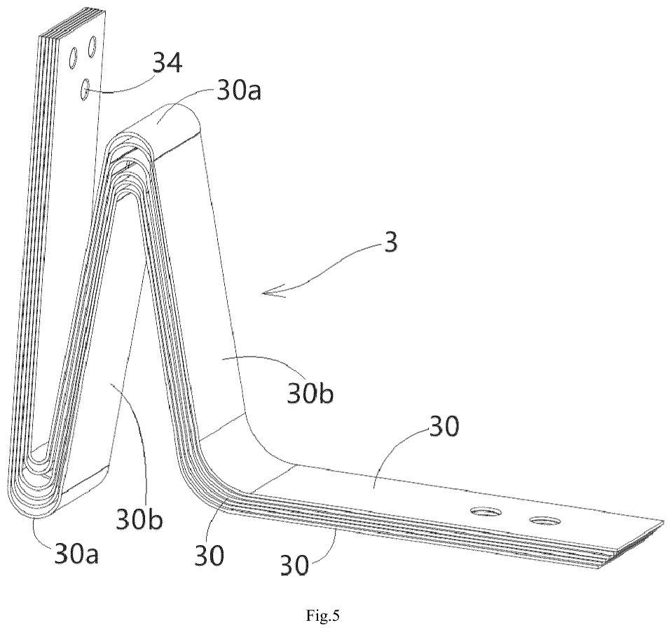

FIG. 1 shows an illustrative perspective view of a connector according to an exemplary embodiment of the present invention. FIG. 2 shows a cross-sectional view of a connector according to an exemplary embodiment of the present invention. FIG. 3 shows an illustrative perspective view of a connector according to an exemplary embodiment of the present invention, with the housing 1 removed. FIG. 4 shows an illustrative perspective view of a terminal 2 of a connector according to an exemplary embodiment of the present invention. FIG. 5 shows an illustrative perspective view of a connection member 3 according to an exemplary embodiment of the present invention.

As shown in FIGS. 1-5, in an exemplary embodiment of the present invention, a connector is disclosed. The connector includes: a housing 1, a terminal 2, a connection member 3, and a positioning pin 4. The housing 1 is formed with a terminal installation chamber 12 and a pin hole 14. The terminal 2 is inserted into the terminal installation chamber 12, the terminal 2 has an end portion 20a and a tail portion 20b that are opposite to each other in a longitudinal direction Y of the housing 1. One end of the connection member 3 is connected to the tail portion 20b of the terminal 2. For example, one end of the connection member 3 is welded, riveted, or crimped to the tail portion 20b of the terminal 2. The positioning pin 4 is inserted into the pin hole 14 and passes through a through hole 34 formed in the connection member 3 and/or the terminal 2 along a transverse direction X of the housing 1, to prevent the terminal 2 from being pulled out of the housing 1.

The positioning pin 4 is located near the tail portion 20b of terminal 2 and passes through the through hole 34 formed in the connection member 3. The diameter of through hole 34 is larger than the diameter of positioning pin 4 to allow the tail portion 20b of terminal 2 to swing left and right relative to the positioning pin 4 in the transverse direction X. However, please note that the present invention is not limited to the illustrated embodiments. For example, the through hole 34 may run through both the connection member 3 and the terminal 2 simultaneously, or the through hole 34 may only run through the terminal 2.

The terminal 2 includes a main terminal 2′ and an auxiliary terminal 2″ stacked on the outer side of the main terminal 2′. The main terminal 20 includes a pair of main elastic arms 20, the main elastic arm 20 has an end portion 20a, a tail portion 20b, and a main body located between the end portion 20a and the tail portion 20b. The auxiliary terminal 2″ includes a pair of auxiliary elastic arms 21, which are respectively stacked on the outer side of the main bodies of the pair of main elastic arms 20.

The tail portions 20b of the pair of main elastic arms 20 of the main terminal 2′ are flat and stacked together, and one end of the connection member 3 is connected to the tail portions 20b of the pair of main elastic arms 20.

The thickness of auxiliary terminal 2″ is smaller than that of main terminal 2′, and the main terminal 2′ and the auxiliary terminal 2″ are made of the same or different conductive materials, used to carry current together to improve the current carrying capacity of the entire terminal 2. For example, in an exemplary embodiment of the present invention, the thickness of the main terminal 2′ may be 1 mm, and the thickness of the auxiliary terminal 2′ may be 0.5 mm, so the total thickness of the terminal is, or is approximately, 1.5 mm.

In the illustrated embodiment, a recess 11 is formed in the housing 1, and the end portion 20a of the main elastic arm 20 is positioned in the recess 11 to limit the floating amount of the end portion 20a of the terminal 2.

The auxiliary elastic arm 21 includes a first end 11a, a second end 12b, and a main body located between the first end 11a and the second end 12b. The first end 11a of the auxiliary elastic arm 21 is close to the end portion 20a of the main elastic arm 20 and is bent back into a hook shape relative to the main body of the auxiliary elastic arm 21. A slot 101 is formed in the housing 1 to allow the insertion of a mating terminal (not shown), and the pair of main elastic arms 20 are used to clamp the inserted mating terminal to make electrical contact with it. When the mating terminal is inserted, the hook shaped first end 11a of the auxiliary elastic arm 21 is pressed against the inner wall surface of the terminal installation chamber 12 to increase the electrical contact force between the terminal 2 and the mating terminal. In this way, the contact resistance of the terminal 2 can be reduced, further improving the current carrying capacity of terminal 2.

The second end 12b of the auxiliary elastic arm 21 is flat and close to the tail portion 20b of the main elastic arm 20, and the second end 12b of the auxiliary elastic arm 21 is connected to the outer side of the main elastic arm 20. For example, the second end 12b of the auxiliary elastic arm 21 can be welded, riveted, or crimped onto the outer side of the main elastic arm 20.

Two terminal installation chambers 12 are formed in the housing 1, and the two terminal installation chambers 12 are arranged side by side in the transverse direction X of the housing 1. The connector includes two terminals 2 and two connection members 3. The two terminals 2 are respectively inserted into the two terminal installation chambers 12, and the two connection members 3 are respectively connected to the two terminals 2.

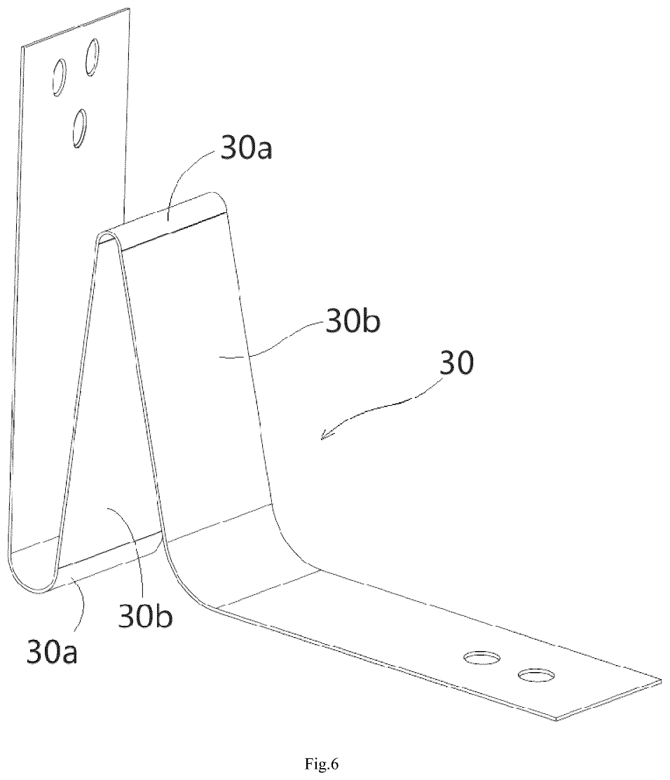

FIG. 6 shows an illustrative perspective view of a layer of metal strip 30 of a connection member 3 according to an exemplary embodiment of the present invention.

As shown in FIGS. 1-6, in the illustrated embodiment, the connection member 3 comprises multiple layers of metal strips 30, which are separated from each other and stacked together. The multiple layer metal strips 30 of the connection member 3 are bent into a predetermined shape to enable the connection member 3 to float elastically. In the exemplary embodiment, the multiple layer metal strips 30 of the connection member 3 are bent into an N-shape or M-shape to allow the connection member 3 to float elastically.

Each layer of metal strip 30 of connection member 3 has at least one arc-shaped bent section 30a, and there is a gap between the arc-shaped bent sections 30a of adjacent layers of metal strips 30 to improve the elastic floating performance of connection member 3. Each layer of metal strip 30 of the connection member 3 has at least one straight extension section 30b, and the straight extension section sections 30b of adjacent layers of metal strips 30 are pressed against each other.

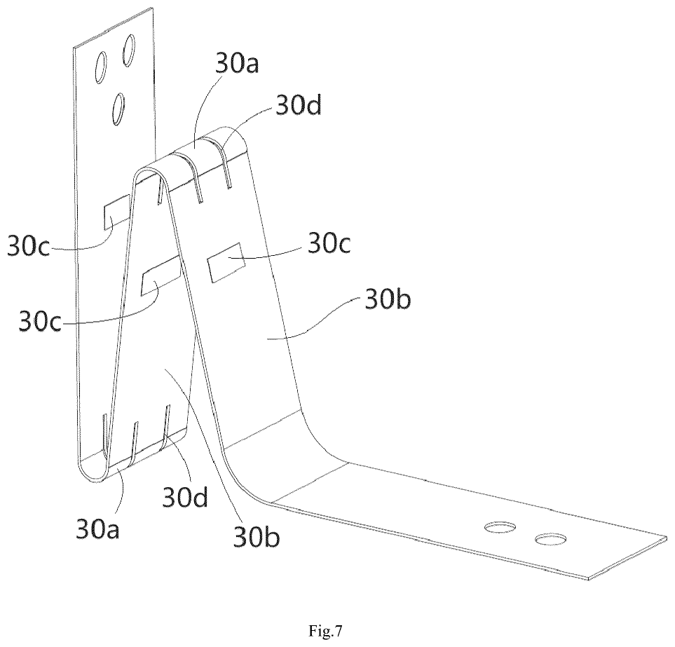

FIG. 7 shows an illustrative perspective view of a layer of metal strip 30 of connection member 3 according to another exemplary embodiment of the present invention.

As shown in FIGS. 1-7, in the illustrated embodiment, each layer of the metal strip 30 of the connection member 3 has at least one straight extension section 30b, and a protrusion 30c is formed on the straight extension section 30b, which is used to space the straight extension sections 30b of adjacent layers of metal strips 30 apart from each other by a predetermined gap, in order to improve the elastic floating performance of the connection member 3.

At least one slit 30d is formed in the arc-shaped bent section 30a of each layer of metal strip 30 of the connection member 3, and the slit 30d extends along the bending direction of the arc-shaped bent section 30a to improve the elastic floating performance of the connection member 3. Multiple slits 30d are formed in the arc-shaped bent section 30a of each layer of metal strip 30 of the connecting member 3, and the multiple slits 30d are distributed at intervals in the width direction of the metal strip 30.

The connector is a power connector, and the terminal 2 is a power terminal used for power supply. The housing 1 has a flange portion for connecting to a mounting panel 5. The flange portion can be connected to the installation panel 5 through screws.

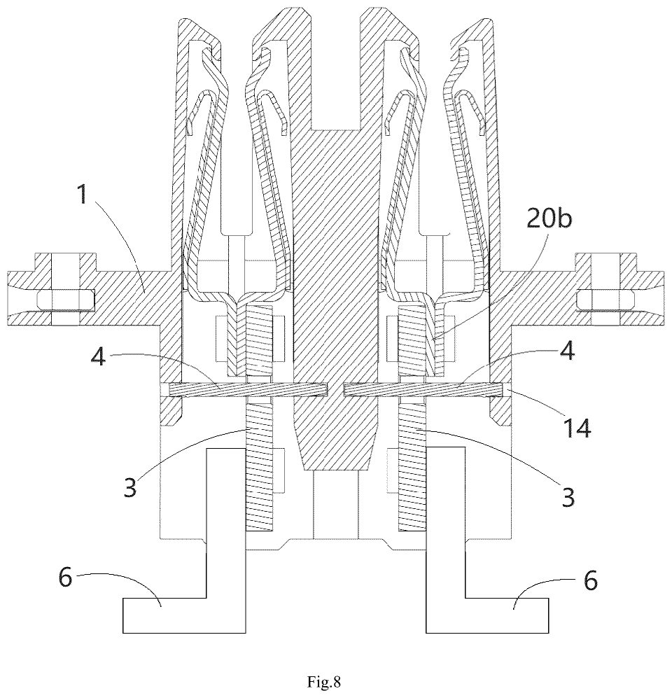

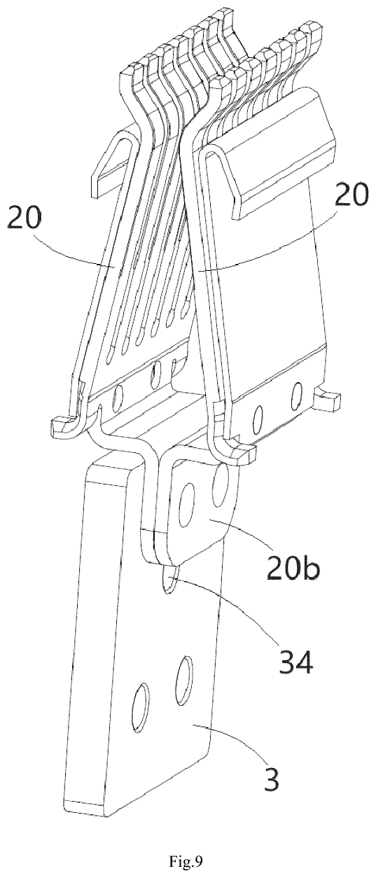

FIG. 8 shows a cross-sectional view of a connector according to another exemplary embodiment of the present invention. FIG. 9 shows an illustrative perspective view of a terminal 2 of a connector according to another exemplary embodiment of the present invention.

Compared with the connector shown in FIGS. 1-7, a primary difference of the connector shown in FIGS. 8-9 is the electrical connection structure connected to the terminal 2. As shown in FIGS. 8 and 9, in the illustrated embodiment, the connection member 3 is a flat adapter terminal used to electrically connect the terminal 2 to a metal bar 6.

The connector further comprises a metal bar 6, one end of which is connected to the connection member 3 for electrical connection to the terminal 2 via the connection member 3. In the illustrated embodiment, the metal bar 6 is a single-layer solid metal bar with a predetermined thickness. The metal bar is bent into a predetermined shape so that it can float elastically.

Except for the above differences, the other technical features of the connector shown in FIGS. 8-9 are essentially the same as those of the connector shown in FIGS. 1-7, which can be referred to as the connector shown in FIGS. 1-7. For the sake of brevity, they will not be repeated here.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing formed with a terminal installation chamber and a pin hole;
a terminal inserted into the terminal installation chamber and having an end portion and a tail portion that are opposite to each other in a longitudinal direction of the housing;
a connection member, one end of which is connected to the tail portion of the terminal; and
a positioning pin inserted into the pin hole and passing through at least one of a through hole formed in the connection member or the terminal along a transverse direction of the housing to prevent the terminal from being pulled out of the housing, a diameter of the through hole is larger than that of the positioning pin to allow the tail portion of the terminal to move relative to the positioning pin in the transverse direction.

2. The connector according to claim 1, wherein the positioning pin is located near the tail portion of the terminal and passes through the through hole formed in the connection member.

3. The connector according to claim 1, wherein:
the terminal comprises a main terminal and an auxiliary terminal stacked on the outer side of the main terminal;
the main terminal comprises a pair of main elastic arms, wherein the main elastic arm includes an end portion, a tail portion, and a main body located between the end portion and the tail portion;
the auxiliary terminal comprises a pair of auxiliary elastic arms, which are respectively stacked on the outer side of the main bodies of the pair of main elastic arms; and
the tail portions of the pair of main elastic arms of the main terminal are flat and stacked together, and one end of the connection member is connected to the tail portions of the pair of main elastic arms.

4. The connector according to claim 3, wherein the thickness of the auxiliary terminal is smaller than that of the main terminal, and the main terminal and the auxiliary terminal are made of the same or different conductive materials, used to carry current together to improve the current carrying capacity of the entire terminal.

5. The connector according to claim 3, wherein a recess is formed in the housing, and the end portion of the main elastic arm is positioned in the recess to limit the floating amount of the end portion of the terminal.

6. The connector according to claim 3, wherein:
the auxiliary elastic arm comprises a first end, a second end, and a main body located between the first end and the second end; the first end of the auxiliary elastic arm is proximate the end portion of the main elastic arm and is bent back into a hook shape relative to the main body of the auxiliary elastic arm;
a slot is formed in the housing to allow the insertion of a mating terminal, and the pair of main elastic arms are used to clamp the inserted mating terminal to make electrical contact with it; and
when the mating terminal is inserted, the hook shaped first end of the auxiliary elastic arm is pressed against an inner wall surface of the terminal installation chamber to increase the electrical contact force between the terminal and the mating terminal.

7. The connector according to claim 6, wherein the second end of the auxiliary elastic arm is flat and proximate the tail portion of the main elastic arm, and the second end of the auxiliary elastic arm is connected to the outer side of the main elastic arm.

8. The connector according to claim 1, wherein:
two terminal installation chambers are formed in the housing, and the two terminal installation chambers are arranged side by side in the transverse direction of the housing; and
the connector comprises two terminals and two connection members, the two terminals are respectively inserted into the two terminal installation chambers, and the two connection members are respectively connected to the two terminals.

9. The connector according to claim 1, wherein the connection member is a flat adapter terminal used to electrically connect the terminal to a metal bar.

10. The connector according to claim 9, further comprising a metal bar, one end of which is connected to the connection member to be electrically connected to the terminal via the connection member.

11. The connector according to claim 10, wherein the metal bar is a single-layer solid metal bar with a predetermined thickness, and is bent into a predetermined shape so that it can float elastically.

12. The connector according to claim 1, wherein the connection member comprises multiple layers of metal strips that are separated from each other and stacked together.

13. The connector according to claim 12, wherein the multiple layer metal strips of the connection member are bent into a predetermined shape so that the connection member can float elastically.

14. The connector according to claim 13, wherein the multiple layer metal strips of the connection member are bent into an N-shape or M-shape to enable the connection member to float elastically.

15. The connector according to claim 13, wherein each layer of metal strip of the connection member has at least one arc-shaped bent section, and there is a gap between the arc-shaped bent sections of adjacent layers of metal strips to improve the elastic floating performance of the connection member.

16. The connector according to claim 15, wherein each layer of the metal strip of the connection member has at least one straight extension section, and the straight extension sections of adjacent layers of metal strips are pressed against each other.

17. The connector according to claim 15, wherein each layer of the metal strip of the connection member has at least one straight extension section, and a protrusion is formed on the straight extension section, which is used to space the straight extension sections of adjacent layers of metal strips apart by a predetermined gap to improve the elastic floating performance of the connection member.

18. The connector according to claim 15, wherein at least one slit is formed on the arc-shaped bent section of each layer of metal strip of the connection member, and the slit extends along the bending direction of the arc-shaped bent section to improve the elastic floating performance of the connection member.

19. The connector according to claim 18, wherein multiple slits are formed on the arc-shaped bent section of each layer of metal strip of the connection member.

20. The connector according to claim 19, wherein the multiple slits are distributed at intervals in the width direction of the metal strip.
